(19) United States
(12) Patent Application Publication
(10) Pub. No.: US 2005/0082732 A1
(43) Pub. Date: Apr. 21, 2005

(54) Multi-layer chopping board

(76) Inventor: Shu-Hui Chang, Houli Township (TW)

Correspondence Address: BACON & THOMAS, PLLC, 625 SLATERS LANE, FOURTH FLOOR, ALEXANDRIA, VA, 22314, US

(21) Appl. No.: 10/689,066

(22) Filed: Oct. 21, 2003

(51) Int. Cl. B23Q 3/00

(52) U.S. Cl. 269/289 R

(57) ABSTRACT

A chopping board includes a main body having a plurality of planks stacked one by one, and a cover layer coated on a periphery of the main body to couple the planks. The planks and the cover layer are made of different materials and the cover layer is softer than the main body.

### BACKGROUND OF THE INVENTION

1. Field of the Invention

The present invention relates generally to a tool used in kitchen, and more particularly to a multi-layer chopping board.

2. Description of the Related Art

A conventional multi-layer chopping board consists of stacked planks. The peripheries of the planks are jointed one by one by heat-fusing method. If the top plank has been damaged, the top plank can be peeled off by cutting off the joint between the top plank and a next plank under the top plank by a knife so that the plank under the top plank is exposed for use. The multi-layer chopping board, therefore, can be used for a long time.

To prevent the plank from being damaged easily, the planks of the multi-layer chopping board are made of hard plastics, but, in the meantime, that make the joint between the planks hard to be split too. In addition, the conventional multi-layer chopping board is easily slippery on the table that might cause danger and inconvenience.

The planks of the conventional multi-layer chopping board are fused at the peripheries to be coupled together so that the shape of the chopping board is limited in a few of simple shapes.

### SUMMARY OF THE INVENTION

The primary objective of the present invention is to provide a multi-layer chopping board, which has a plurality of stacked planks that are easy to be peeled off from one another.

The secondary objective of the present invention is to provide a multi-layer chopping board, which is skidproof.

The third objective of the present invention is to provide a multi-layer chopping board, which has various models.

According to the objectives of the present invention, a chopping board comprises a main body having a plurality of planks stacked one by one, and a cover layer coated on a periphery of the main body to couple the planks. The planks and the cover layer are made of different materials.

### BRIEF DESCRIPTION OF THE DRAWINGS

FIG. 1 is a perspective view of a first preferred embodiment of the present invention;

FIG. 2 is a sectional view taken along line 2-2 of FIG. 1;

FIG. 3 is a sectional view of the first preferred embodiment of the present invention, showing another type of the chopping board;

FIG. 4 is a perspective view of a second preferred embodiment of the present invention;

FIG. 5 is a sectional view taken along line 5-5 of FIG. 4;

FIG. 6 is a perspective view of the second preferred embodiment of the present invention, showing how to peel off the top plank;

FIG. 7 is a perspective view in a part of a third preferred embodiment of the present invention;

FIG. 8 is a perspective view of a fourth preferred embodiment of the present invention;

FIG. 9 is a perspective view of a fifth preferred embodiment of the present invention;

FIG. 10 is a sectional view taken along line 9-9 of FIG. 8;

FIG. 11 is a perspective view of a sixth preferred embodiment of the present invention;

FIG. 12 is a sectional view of a seventh preferred embodiment of the present invention;

FIG. 13 is a sectional view of a eighth preferred embodiment of the present invention, and

FIG. 14 is a sectional view of a ninth preferred embodiment of the present invention.

### DETAILED DESCRIPTION OF THE INVENTION

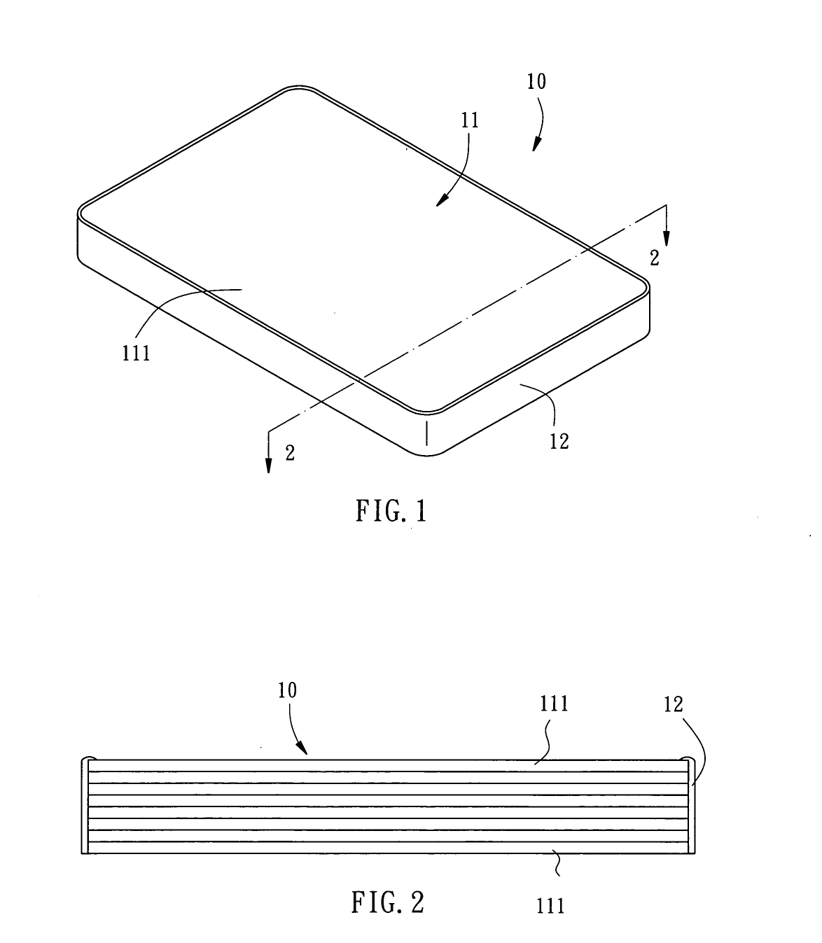

As shown in FIG. 1 and FIG. 2, a multi-layer chopping board 10 of the first preferred embodiment of the present invention comprises a main body 11 and a cover layer 12.

The main body 11 consists of a plurality of planks 111, which are made of Polyethylene (PE) or other suitable plastics materials. The planks 111 stack one by one to form the main body 11.

The cover layer 12 is made of rubber added Polyethylene (PE), Thermoplastic Rubber (TPR) or other suitable materials that are softer than the main body 11. The cover layer 12 is molded on a periphery of the main body 11 to couple planks 111 together by injection molding of second time or other suitable methods. The cover layer 12 is preferred made of a material that is easy to be fused with the planks 111 of the main body 11. The cover layer 12 seals the peripheries of the planks 111 of the main body 11 to prevent water and dust running in between the planks 111.

The present invention provides the cover layer 12 that is softer than the planks 111 of the main body 11 so that a knife is easy to cut the cover layer 12 off and stab in between the planks 111 of the main body 11 to peel the damaged plank 111 off.

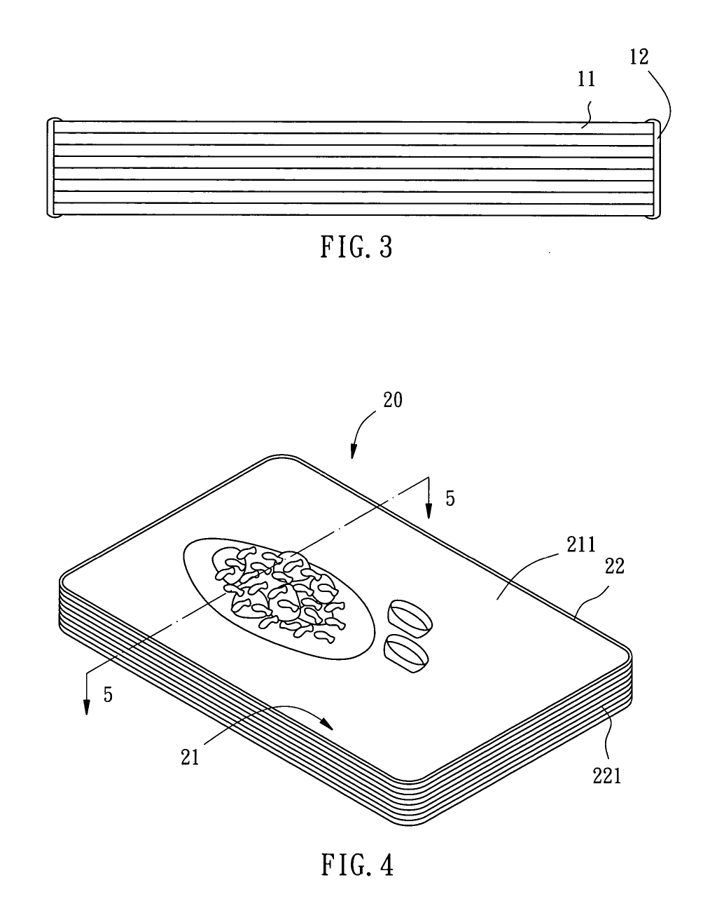

FIG. 3 shows the cover layer 12 molded both on the peripheries of the planks 111 and portions of opposite sides of the main body 11 at where adjacent to the periphery thereof. While the chopping board 10 of the present invention is put on a table, the cover layer 12 on the bottom side of the main body 11 is against the table rather than the planks 111 so that the chopping board 10 has a greater friction for skidproof.

As shown in FIGS. 4-6, the second preferred embodiment of the present invention provides a multi-layer chopping board 20 having a main body 21, which consists of a plurality of stacked planks 211, and a cover layer 22.

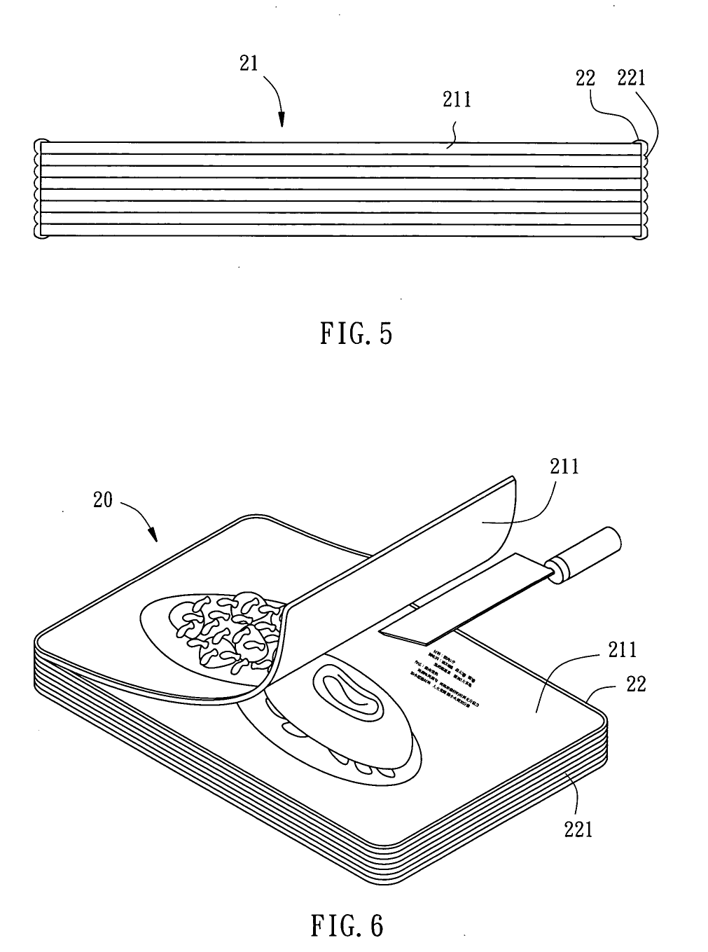

The cover layer 22 is molded on peripheries of the planks 211 of the main body 21 and the cover layer 22 has a plurality of guiding portions 221, which are parallel recesses on the cover layer 22 at where between the planks 211 respectively, as shown in FIG. 4 and FIG. 5, i.e. the guiding portions correspond in location to the stacked positions of the planks respectively.

If the plank 211 needs to be peeled off, user can put a knife in the guiding portion 221 of the cover layer 22 and exert it to cut the cover layer 22 off and stab in between the planks 211 directly. The guiding portions 221 of the cover layer 22 index where the knife should cut and prevent the knife from sliding. As shown in FIG. 6, the planks 211 are printed with specific pictures, textures or icons that make the chopping board 20 of the present invention fancier.

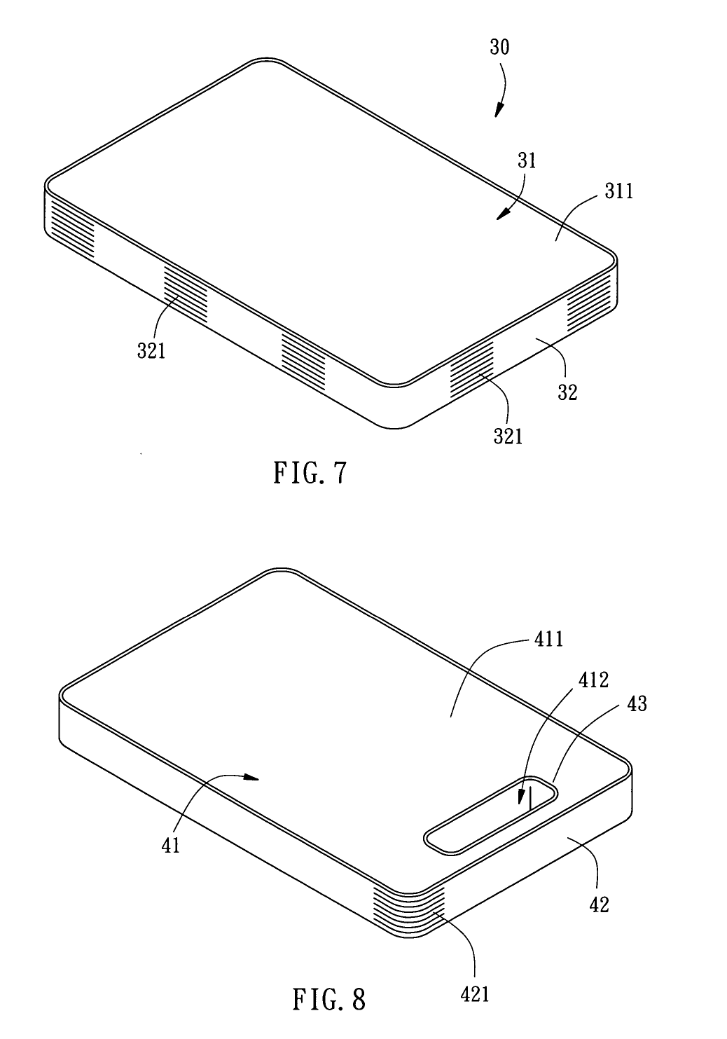

FIG. 7 shows a multi-layer chopping board 30 of the third preferred embodiment of the present invention having a main body 31 and a cover layer 32. The cover layer 32 has a plurality of guiding portions 321 and the guiding portions 321 are parallel but discontinuous recesses on the cover layer 32.

FIG. 8 shows a chopping board 40 of the fourth preferred embodiment of the present invention having a main body 41 consisting of stacked planks 411 and a cover layer 42 with guiding portions 421. Each plank 411 has an opening at same location so that the main body 41 has a hole 412 and a cover layer 43 is molded on a sidewall of the hole 412. The hole 412 facilitate user to hold the chopping board 40.

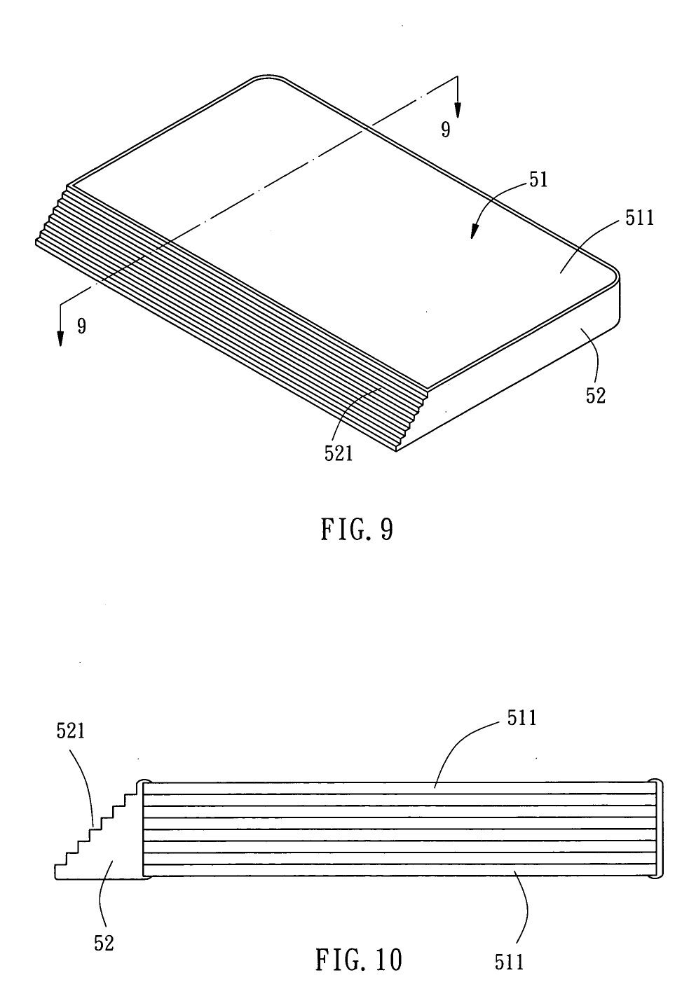

FIG. 9 and FIG. 10 show a chopping board 50 of the fifth preferred embodiment of the present invention having a main body 51 consisting of stacked planks 511 and a cover layer 52. The cover layer 52 has a stepped lateral side, and each step of the stepped lateral side forms a guiding portion 521. In other words, the stepped lateral side of the cover layer 52 has a plurality of vertical planes and horizontal planes that correspond in location to the stacked positions between two planks respectively. User attaches a knife on the horizontal plane and exerts it to cut the vertical plane off, and then the knife will stab in between the planks 511 continuously.

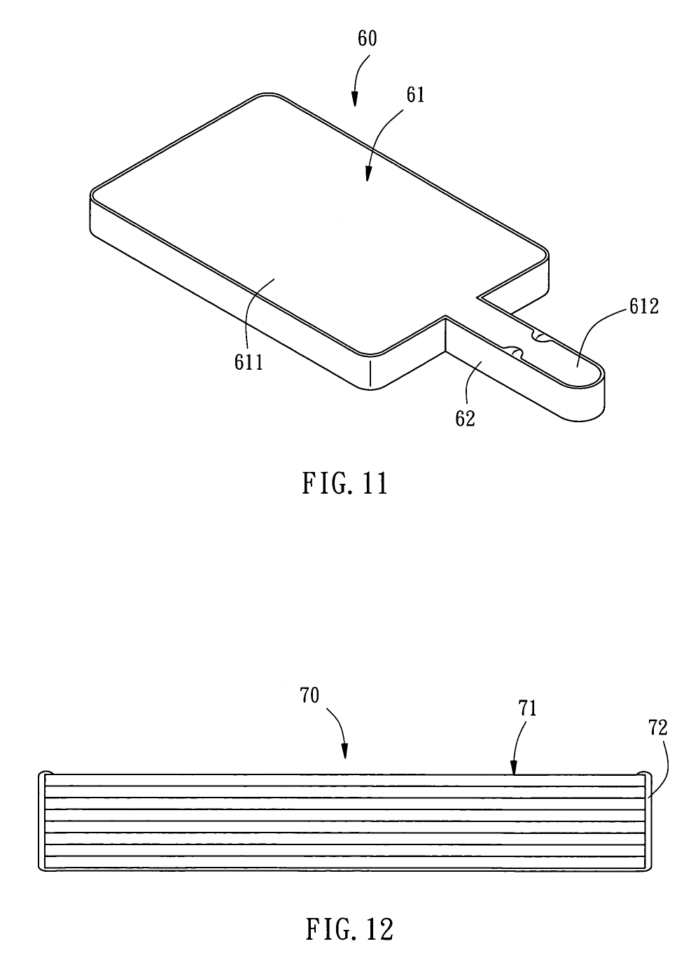

FIG. 11 shows a chopping board 60 of the sixth preferred embodiment of the present invention having a main body 61 consisting of stacked planks 611 and a cover layer 62. The chopping board 60 has a handle 612, which is also consisted of the planks 611, and the handle 612 is surrounded by the cover layer 62 at its periphery too.

FIG. 12 shows a chopping board 70 of the seventh preferred embodiment of the present invention having a main body 71 consisting of stacked planks 711 and a cover layer 72. The cover layer 72 is provided on a periphery and a bottom of the main body 71. The cover layer 72 on the bottom of the main body 71 provides more friction while the chopping board 70 is put on a table. The chopping board 70 of the seven preferred embodiment, therefore, has a well capacity of skidproof.

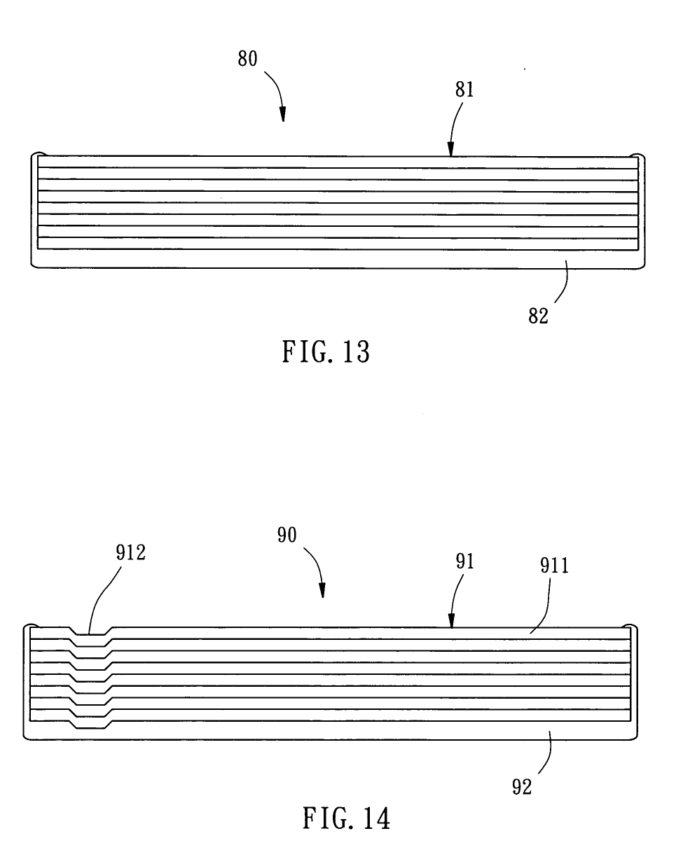

FIG. 13 shows a chopping board 80 of the eighth preferred embodiment of the present invention, similar to the seventh preferred embodiment, having a main body 81 consisting of stacked planks 811 and a cover layer 82 molded on both a periphery and a bottom of the main body 81. The cover layer 82 on the bottom of the main body 81 has a suitable thickness. If there is only a plank 811 left, the chopping board 80 still has a suitable thickness for cutting something on it.

FIG. 14 shows a chopping board 90 of the ninth preferred embodiment of the present invention having a main body 91 consisting of stacked planks 911 and a cover layer 92, wherein each plank 911 further has a positioning portion 912. The positioning portion 912 is a curved portion on the plank 911 and the positioning portions 912 are engaged with the next one while the planks 911 are stacked. The planks 911 are stacked well to facilitate the cover layer 92 molded thereon.

1. A chopping board, comprising:
a main body having a plurality of planks stacked one by one, and
a cover layer coated on a periphery of the main body to couple the planks, wherein the planks and the cover layer are made of different materials.

2. The chopping board as defined in claim 1, wherein the cover layer has a hardness smaller than that of the main body.

3. The chopping board as defined in claim 1, wherein the cover layer is provided with a plurality of guiding portions corresponding in location to stacked positions of the planks respectively.

4. The chopping board as defined in claim 3, wherein the guiding portions are parallel annular recesses on the cover layer.

5. The chopping board as defined in claim 3, wherein the guiding portions are parallel but discontinuous recesses on the cover layer.

6. The chopping board as defined in claim 3, wherein the guiding portions are only provided on a part of the cover layer.

7. The chopping board as defined in claim 1, wherein the cover layer has a stepped lateral side such that each step of the stepped lateral side forms a guiding portion.

8. The chopping board as defined in claim 3, wherein said cover layer comprises a stepped lateral side having a plurality of horizontal planes forming said guiding portions respectively.

9. The chopping board as defined in claim 1, wherein each of the planks is provided with a predetermined picture or texture thereon.

10. The chopping board as defined in claim 1, wherein each of the planks has an opening at same locations thereof so that the main body has a hole and a cover layer is molded on a sidewall of the hole.

11. The chopping board as defined in claim 1, wherein each of the planks is provided with a positioning portion respectively, wherein the position portions are curved portions of the planks and the position portions are engaged with the next one respectively while the planks are stacked.

12. The chopping board as defined in claim 1, wherein the cover layer is further coated on a bottom of the main body.
